(19) United States
(12) Patent Application Publication
(10) Pub. No.: US 2003/0025111 A1
(43) Pub. Date: Feb. 6, 2003

(54) Device for maintaining tension in a cable

(76) Inventor: Stanley J. Checketts, Providence, UT (US)

Correspondence Address: FEHR LAW FIRM, Suite 300, Golenwest Corporate Center, 5025 Adams Avenue, Ogden, UT, 84403, US

(21) Appl. No.: 09/922,547

(22) Filed: Aug. 3, 2001

(51) Int. Cl. B66D 3/04

(52) U.S. Cl. 254/413

(57) ABSTRACT

A device for maintaining tension in a cable used to propel a carrier for one or more participants on an amusement ride. The device can be attached at the end of a cable where the propulsive force for the carrier is supplied at an intermediate point along the cable. It can also be connected to an intermediate point of the cable when the propulsive force for the carrier is supplied at an end of the cable. In the first situation a spring, a pressurizable cylinder having a rod attached to a piston, or a pressurizable cylinder with a piston may be connected to the cable and a heavy object; or a weight may be suspended from the cable. In the latter situation a slide is mounted on the cable attached to a line and weight, a spring is attached to a rigid structure, a pressurizable cylinder transversely pushes the cable, or a pressurizable cylinder transversely pulls the cable.

### BACKGROUND OF THE INVENTION

1. Field of the Invention

This invention relates to an apparatus for reducing slackness in a cable used to propel a carrier for one or more participants on an amusement ride.

2. Descriptions of the Related Art

The inventor is unaware of any existing device for reducing slackness in a cable used to propel a carrier of an amusement ride.

### SUMMARY OF THE INVENTION

Especially, but not exclusively, with amusement rides that utilize a cable to propel a carrier for one or more participants in a substantially vertical direction, the cable attached to the carrier can, as the carrier approaches one of its spatial limits, tend to become slack.

One mechanism for causing the end of the cable attached to the carrier to exert the propulsive force in the desired direction pulls such cable at a point on the cable intermediate between the ends of such cable. When such a mechanism is utilized to generate the substantially vertical force, slackness in the cable is reduced by employing a device that exerts a pulling force along the cable in the direction away from the carrier to which such cable is attached. This pulling force is applied to the end of the cable other than the end that is connected to the carrier.

Rather than exerting a force at an intermediate point along the cable, another mechanism for causing the end of the cable attached to the carrier to exert the propulsive force in the desired direction exerts a pulling force on the cable from the end of the cable other than the end that is connected to the carrier. When this propulsive mechanism is employed. Slackness in the cable is reduced by using a device that exerts either a pushing or a pulling force substantially transverse to the cable at an intermediate point of the cable.

### BRIEF DESCRIPTION OF THE DRAWINGS

FIG. 1 depicts a spring used at the end of a cable to reduce slackness.

FIG. 2 shows a weight attached to the end of a cable to reduce slackness.

FIG. 3 illustrates a cylinder connected to the end of a cable to reduce slackness.

FIG. 4 portrays a spring used at an intermediate point of a cable to reduce slackness.

FIG. 5 demonstrates a weight used at an intermediate point of a cable to reduce slackness.

FIG. 6 shows a cylinder pushing against a cable at an intermediate point to reduce slackness.

FIG. 7 illustrates a cylinder pulling against a cable at an intermediate point to reduce slackness.

### DESCRIPTION OF THE PREFERRED EMBODIMENT

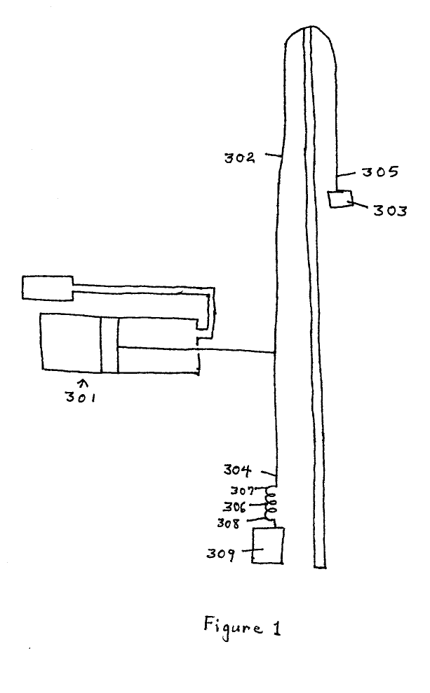

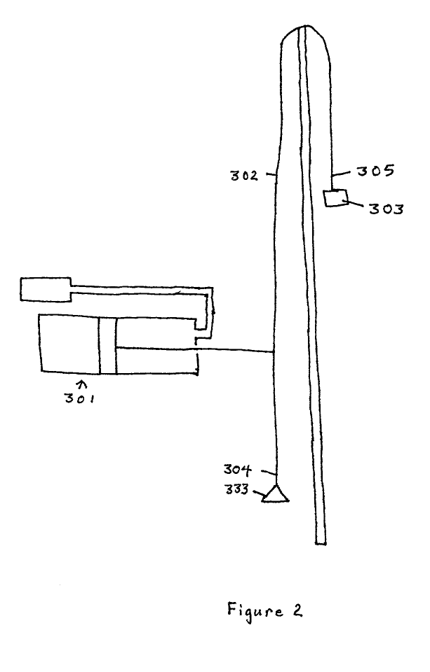

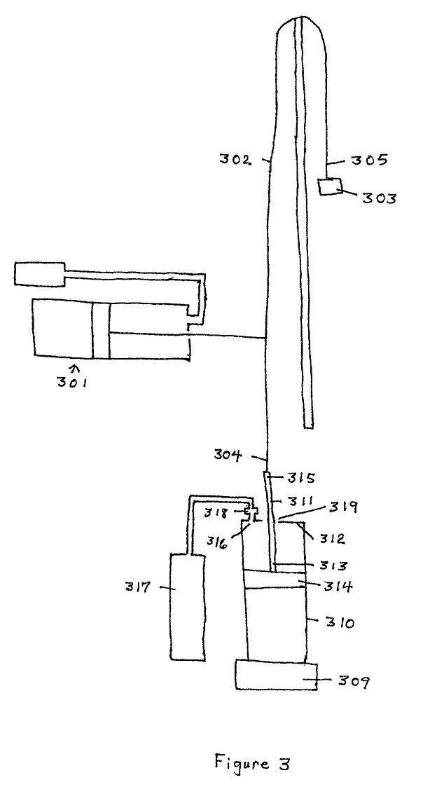

FIG. 1, FIG. 2, and FIG. 3 include an exemplary mechanism 301 for exerting a force at an intermediate point along a cable 302 in order to propel a carrier 303 for one or more participants in a substantially vertical direction. As an example, a cylinder employing compressed gas is shown.

With such an embodiment of the propulsive mechanism for the carrier 303, in order to reduce slackness in the cable 302 as the carrier 303 approaches its upper vertical limit, a means is employed for applying a pulling force along the cable 302 in the direction away from the carrier 303 to which such cable 302 is attached. This pulling force is applied to the end 304, designated the first end, of the cable 302 other than the end 305, designated the second end, that is connected to the carrier 303.

Examples of devices which can create the pulling force are a spring 306 having a first end 307 connected to the first end 304 of the cable 302 and a second end 308 connected to an object 309 which is so heavy that movement of the carrier 303 will not appreciably move the object 309, as illustrated in FIG. 1; a weight 333 suspended from the first end 304 of the cable, as shown in FIG. 2; and a pressurizable cylinder 310 connected to the object 309 and having a rod 311 extending through an end 312 of the cylinder 310 with the first end 313 of the rod 311 attached to a piston 314 slidably mounted within the cylinder 310 and the second end 315 of the rod 311 attached to the first end 304 of the cable 302, as portrayed in FIG. 3. Alternatively, the rod 311 can be eliminated; and the cable 302 is then connected directly to the piston 314. The object 309 is preferably the earth or a structure attached to the earth. The pressurizable cylinder 310 has an aperture 316 connected to a source 317 of compressed fluid, preferably a gas, through a pressure regulator 318; such aperture 316 is preferably near, i.e., closer than the piston 314 will ever be to, the end of the pressurizable cylinder 310 through which the rod 311 extends. Also, an aperture 319 exists in the end 312 of the cylinder to allow the rod 311 or cable 302 to pass through the end 312.

Of the various devices, the pressurizable cylinder 310 is preferred.

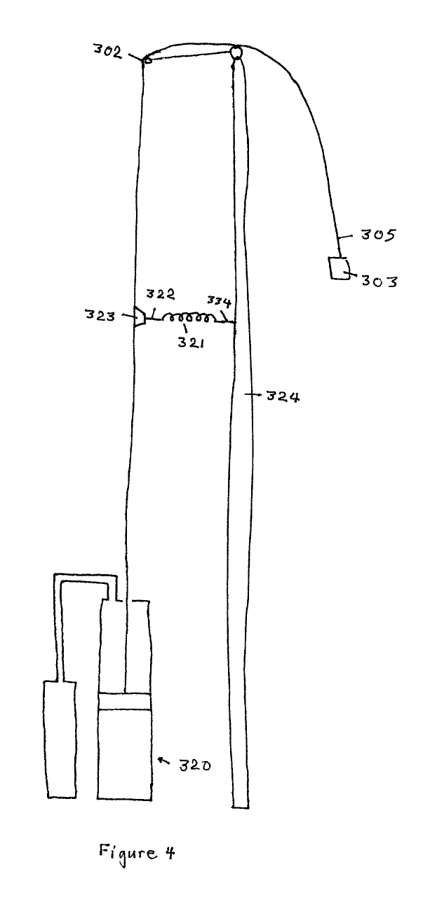

FIGS. 4 through 7 include an exemplary mechanism 320 for exerting a force at the first end 304 of the cable 302 in order to propel a carrier 303 for one or more participants in a substantially vertical direction. Again as an example, a cylinder employing compressed gas is shown.

In order to reduce slackness in the cable 302 with such an embodiment of the propulsive mechanism for a carrier 303, a means for applying a force substantially transverse to the cable 302 at an intermediate point of the cable 302 is utilized.

One example of such a means is, as shown in FIG. 4, a spring 321 having a first end 322 attached to a slide 323 through which the cable 302 can freely move and a second end 334 attached to a rigid structure 324, which could, for example, be a tower from which the cable 302 is supported. The slide 323 can, but need not, totally encircle the cable 302; it is sufficient that the slide 323 goes far enough around the cable 302 to prevent the cable 302 from slipping away from the slide 323.

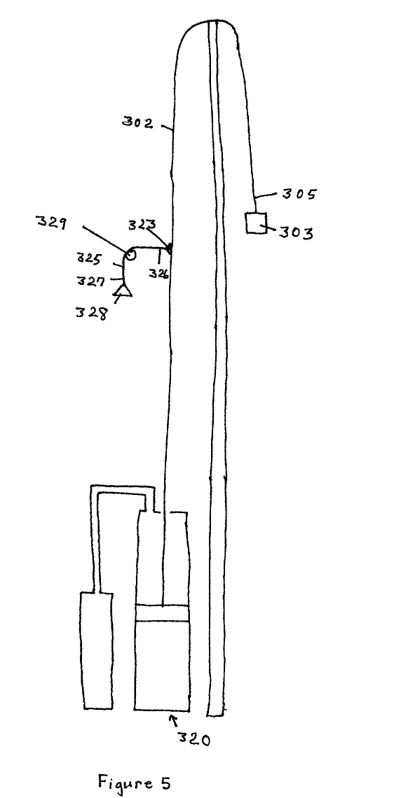

Another example of a means for applying the substantially transverse force is, as illustrated in FIG. 5, a line 325 that has a first end 326 attached to the slide 323 and a second end 327 connected to a weight 328 with the line 325 passing at an intermediate point between the ends 326, 327 around a substantially horizontal structure 329, which is preferably a pulley, to suspend the weight 328.

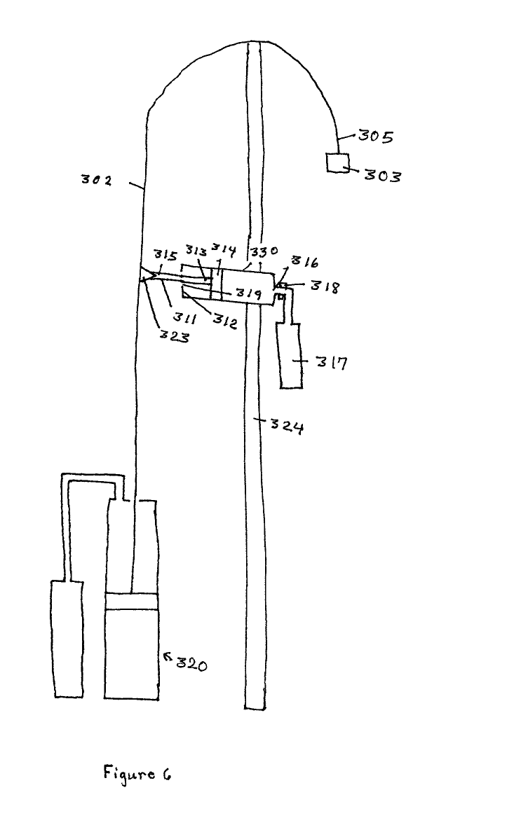

A third example of a means for applying the substantially transverse force is, as depicted in FIG. 6, a pressurizable cylinder 330 connected to the rigid structure 324 and having a rod 311 extending through an end 312 of the cylinder 330 with the first end 313 of the rod 311 attached to a piston 314 slidably mounted within the cylinder 330 and the second end 315 of the rod 311 attached to the slide 323. The cylinder 330 is constructed just as is the cylinder 310 except that aperture 316 is preferably near the end of the pressurizable cylinder 330 opposite to the end 312 through which the rod 311 extends because it is desired to have the gas exert a force which tends to push the rod 311 from the cylinder 330 rather than tending to pull the rod 311 into the cylinder 330.

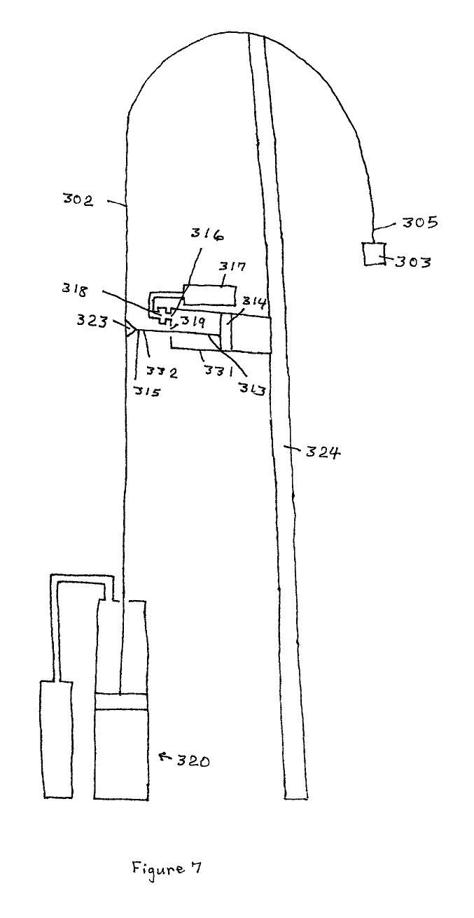

Still another example of a means for applying the substantially transverse force is portrayed in FIG. 7. A pressurizable cylinder 331 is connected to the rigid structure 324, has a force transferring device 332, which may be either a rod or cable, with the first end 313 of the force transferring device 332 attached to the piston 314, and has the second end 315 of the force transferring device 332 connected to the slide 323. In all other respects the pressurizable cylinder is the same as pressurizable cylinder 310.

I claim:

1. A device for maintaining tension in a cable used to propel a carrier for one or more participants on an amusement ride when the propulsive force is exerted at an intermediate point along a cable, which comprises:
a spring having a first end connected to a first end of the cable and having a second end connected to an object which is so heavy that movement of the carrier will not appreciably move the object.

2. A device for maintaining tension in a cable used to propel a carrier for one or more participants on an amusement ride when the propulsive force is exerted at an intermediate point along a cable, which comprises:
a pressurizable cylinder connected to an object which is so heavy that movement of the carrier will not appreciably move the object and having a rod extending through an end of the cylinder with a first end of the rod attached to a piston slidably mounted within the cylinder and a second end of the rod attachable to a first end of a cable, said pressurizable cylinder also having an aperture for connection to a source of compressed fluid near an end of the pressurizable cylinder and an aperture in that end of the pressurizable cylinder to allow the rod to pass through the end of the pressurizable cylinder.

3. A device for maintaining tension in a cable used to propel a carrier for one or more participants on an amusement ride when the propulsive force is exerted at an intermediate point along a cable, which comprises:
a pressurizable cylinder connected to an object which is so heavy that movement of the carrier will not appreciably move the object, said pressurizable cylinder having a piston slidably mounted within the cylinder for attachment to a first end of a cable, said pressurizable cylinder also having an aperture for connection to a source of compressed fluid near an end of said cylinder, and said pressurizable cylinder having an aperture in that end of the pressurizable cylinder to allow a cable to pass through the end of the pressurizable cylinder.

4. A device for maintaining tension in a cable used to propel a carrier for one or more participants on an amusement ride when the propulsive force is exerted at an intermediate point along a cable, which comprises:
a weight having a mechanism for attaching and suspending said weight from a cable.

5. A device for maintaining tension in a cable used to propel a carrier for one or more participants on an amusement ride when the propulsive force is exerted at a first end of the cable, which comprises:
a slide through which a cable can freely move;
a spring having a first end attached to said slide and a second end attached to a rigid structure.

6. A device for maintaining tension in a cable used to propel a carrier for one or more participants on an amusement ride when the propulsive force is exerted at a first end of the cable, which comprises:
a slide through which a cable can freely move;
a substantially horizontal structure;
a line having a first end attached to said slide; and
a weight connected to a second end of said line after said line has passed over a substantially horizontal structure.

7. A device for maintaining tension in a cable used to propel a carrier for one or more participants on an amusement ride when the propulsive force is exerted at a first end of the cable, which comprises:
a slide through which a cable can freely move;
a pressurizable cylinder connected to a rigid structure and having a rod extending through an end of the cylinder with a first end of the rod attached to a piston slidably mounted within the cylinder and a second end of the rod attached to said slide, said pressurizable cylinder also having an aperture for connection to a source of compressed fluid in such a location as to have any introduced fluid tend to push the rod from the cylinder and an aperture in an end of the pressurizable cylinder to allow the rod to pass through the end of the pressurizable cylinder.

8. A device for maintaining tension in a cable used to propel a carrier for one or more participants on an amusement ride when the propulsive force is exerted at a first end of the cable, which comprises:
a slide through which a cable can freely move;
a pressurizable cylinder connected to a rigid structure and having a force transferring device extending through an end of the cylinder with a first end of the force transferring device attached to a piston slidably mounted within the cylinder and a second end of the force transferring device attached to said slide, said pressurizable cylinder also having an aperture for connection to a source of compressed fluid in such a location as to have any introduced fluid tend to pull the rod into the cylinder and an aperture in an end of the pressurizable cylinder to allow the rod to pass through the end of the pressurizable cylinder.
